(19) United States
(12) Patent Application Publication
(10) Pub. No.: US 2026/0249974 A1
(43) Pub. Date: Aug. 27, 2026

(54) BREAKAWAY AIRCRAFT STRUCTURES

(71) Applicant: SUPERNAL, LLC, Washington, DC (US)

(72) Inventor: Rajan KHATRI, Washington, DC (US)

(21) Appl. No.: 18/994,298

(22) PCT Filed: Aug. 29, 2023
(86) PCT No.: PCT/US2023/073098

§ 371 Date: Jan. 14, 2025

Related U.S. Application Data
(60) Provisional application No. 63/373,952, filed on Aug. 30, 2022.

(51) Int. Cl. B64C 1/26; B64D 25/00; F16B 31/00; F16B 31/02

(52) U.S. Cl. CPC B64C 1/26; B64D 25/00; F16B 31/005; F16B 31/021

(57) ABSTRACT

An aircraft is disclosed. The aircraft includes a body and a wing coupled to the body. The aircraft further includes a boom coupled to the wing at a first location and a second location, and a fuse pin coupling the boom to the wing at the second location. The fuse pin is configured to fracture or plastically deform above a threshold load.

### CROSS REFERENCE TO RELATED APPLICATION

The present disclosure claims priority to U.S. application No. 63/373,952, filed on Aug. 30, 2022, the entire contents of which are herein incorporated by reference.

### FIELD OF THE DISCLOSURE

The present disclosure relates to systems, methods, and devices for vehicles, aircraft, and airframe structures.

### BACKGROUND

High wing aircraft are popular because of the visibility they afford passengers, the ease of egress and ingress without the need for stepping on a wing, and efficient structures that carry an aircraft's weight on the wings while also providing mounting locations for propellers, rotors, fuel, batteries, and the like.

However, if a high wing structure is heavy and/or loaded, it may present a hazard for a compartment or a body of an aircraft if the weight or load of the wing overcomes a threshold of one or more structures under the wing. For example, passengers, cargo, or other aircraft structure could be damaged.

Further, for craft with one or more proprotors that may move between a horizontal thrust configuration and a vertical thrust configuration, those proprotors can be mounted on a wing. In such a configuration, the wings of the craft may be required to bear a substantial amount of weight due to proprotors and/or other support structure, equipment, and motors associated with the proprotors. Similarly, some craft may include lift rotors mounted on the wings, such as lift rotors intended to generate vertical thrust. Lift rotors may also add weight to the wings due to the additional support structure, equipment, and motors associated with the lift rotors.

Moreover, although aircraft can nominally withstand the loads from devices and structures on a wing during normal operations, certain conditions such as extreme weather (wind, rain, snow, and the like) or a hard landing may present additional challenges to the supportability of a wing. For example, when the loads from devices and structures affixed to a wing increase due to severe weather, a hard landing, a crash landing, or the like, the wing structure may transfer these additional loads through the body structure. The body structure can then be damaged, as discussed above. Such damage may result in structural failure, which may be a significant concern as it can result in loss or damage to the aircraft, including its ability to fly or move.

Accordingly, improvements to airframe structure to avoid significant structural damage are desirable.

### SUMMARY

In the following description, certain aspects and embodiments will become evident. It is contemplated that the aspects and embodiments, in their broadest sense, could be practiced without having one or more features of these aspects and embodiments. It is also contemplated that these aspects and embodiments are merely exemplary.

In a first example embodiment, an aircraft is provided. The aircraft includes a body, a wing coupled to the body, a boom coupled to the wing at a first location and a second location, and a fuse pin coupling the boom to the wing at the second location. The fuse pin is configured to fracture or plastically deform above a threshold load.

In some embodiments, the fuse pin includes a forward pin and an aft pin, where the aft pin is configured to fracture or plastically deform before the forward pin.

In some embodiments, the aircraft further includes a second fuse pin at the first location, where the second fuse pin is configured to fracture or plastically deform above a second threshold load different than the threshold load.

In some embodiments, upon exceeding the threshold load, the boom detaches from the wing at the second location and the first location forms a pivot point, and where upon exceeding the second threshold load, the boom completely detaches from the wing at the first and second location.

In some embodiments, the fuse pin includes an upper fuse pin and a lower fuse pin, where the lower fuse pin is configured to fracture or plastically deform before the upper fuse pin.

In some embodiments, the boom includes a center of gravity, where the first location is on a first side of the center of gravity and the second location is on a second side opposite the first side.

In some embodiments, the first side is forward of the center of gravity and the second side is aft of the center of gravity.

In some embodiments, the first location forms a pivot point for the boom, such that upon fracture of the fuse pin at the second location, the boom rotates about the pivot point.

In some embodiments, the first location further includes the fuse pin.

In some embodiments, a length of the fuse pin is aligned longitudinal with the wing.

In some embodiments, a pivot bar couples the boom to the wing at either the first and/or second location, the pivot bar coupled at a first end to the wing and at a second end to the boom.

In some embodiments, the first end forms a pivot point about which the boom and the pivot bar rotate.

In some embodiments, the fuse pin couples the boom to the pivot bar at the second end.

In some embodiments, at least one fixed bolt couples the pivot bar to the boom and the wing at the first location and at least one of the fuse pins couples a second pivot bar to the boom and the wing at the second location, such that the boom detaches from the wing at the second location upon exceeding the threshold load.

In a second example embodiment, an aircraft is provided. The aircraft includes a first aircraft structure. The aircraft also includes a second aircraft structure coupled to the first aircraft structure, where the second aircraft structure includes a local center of gravity. The aircraft further includes a fuse pin coupling the first aircraft structure to the second aircraft structure aft of the local center of gravity. The fuse pin is configured to fracture or plastically deform above a threshold load.

In some embodiments, the first aircraft structure is coupled to the second aircraft structure at a first location forward of the local center of gravity and a second location aft of the local center of gravity.

In some embodiments, the fuse pin couples the first aircraft structure to the second aircraft structure at the second location and the first aircraft structure is pivotally coupled to the second aircraft structure at the first location.

In some embodiments, the second aircraft structure detaches from the first aircraft structure at the second location upon exceeding the threshold load and rotates about the first location.

In some embodiments, the second location includes the fuse pin and the first location includes a second fuse pin, the second fuse pin configured to fracture or plastically deform above a second threshold load different than the threshold load.

In some embodiments, where upon exceeding the threshold load the second aircraft structure detaches from the first aircraft structure at the second location and the first location forms a pivot point, and where upon exceeding the second threshold load the second aircraft structure completely detaches from the first aircraft structure at the first and second location.

In some embodiments, a pivot bar couples the first aircraft structure to the second aircraft structure at either the first and/or second location, the pivot bar coupled at a first end to the first aircraft structure and at a second end to the second aircraft structure.

In some embodiments, the first end forms a pivot point about which the second aircraft structure and the pivot bar rotate.

In some embodiments, the fuse pin couples the second aircraft structure to the pivot bar at the second end.

In some embodiments, the first aircraft structure is a first wing portion proximal to a body of the aircraft and the second aircraft structure is a second wing portion distal to the body.

It is to be understood that both the foregoing general description and the following detailed description are exemplary and explanatory only and are not restrictive of the invention. The accompanying drawings, which are incorporated in and constitute a part of this specification, illustrate several exemplary embodiments and together with the description, serve to outline principles of the exemplary embodiments.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1 illustrates a craft in a vertical take-off and landing configuration, according to an exemplary embodiment of the present disclosure.

FIG. 2 illustrates a perspective view of aspects of a craft, according to an exemplary embodiment of the present disclosure.

FIGS. 3A-3B illustrate an aircraft including a detachable structure, according to an exemplary embodiment of the present disclosure.

FIG. 4 illustrates an aircraft including a detachable structure, according to an exemplary embodiment of the present disclosure.

FIG. 5 illustrates an attachment point on an aircraft, according to an exemplary embodiment of the present disclosure.

### DETAILED DESCRIPTION

Reference will now be made in detail to exemplary embodiments shown in the accompanying drawings.

Exemplary disclosed embodiments include devices, systems, and methods for vehicles, aircraft, and aircraft structure. In some embodiments, vehicle or aircraft structure may be configured to selectively detach, avoiding significant structural damage. For example, disclosed vehicle or aircraft structure may include fuse pins that are configured to plastically deform before vehicle or aircraft structure or other components are damaged. Vehicle or aircraft structure may include wings that include the fuse pins.

Consistent with disclosed embodiments, the aircraft structure may be configured to generate lift and/or fly. As used herein, aircraft structure may refer to structure of an aerial, floating, soaring, hovering, airborne, aeronautical aircraft, airplane, plane, spacecraft, vessel, or other vehicle moving or able to move through air. Some non-limiting examples may include a helicopter, an airship, a hot air balloon, an airplane, a vertical take-off and landing (VTOL) craft, an unmanned aerial vehicle, or a drone.

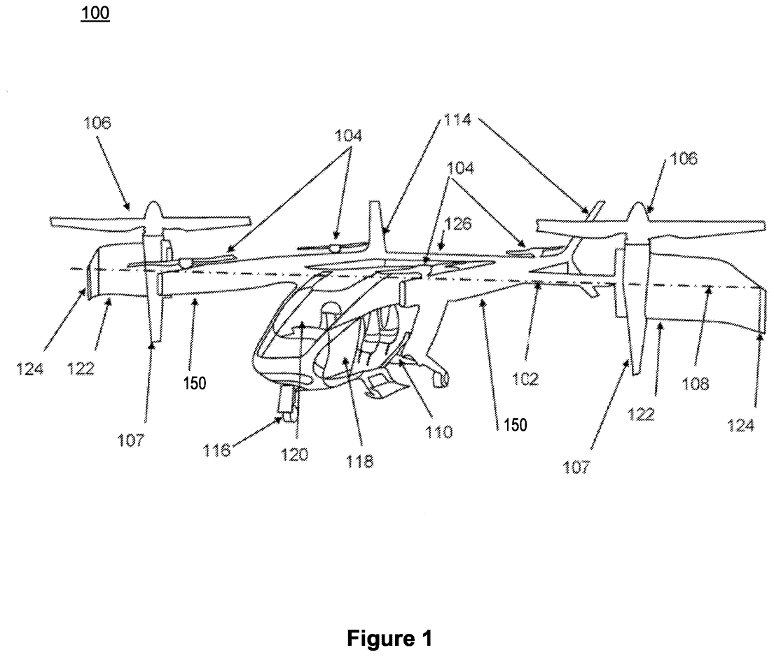

FIG. 1 illustrates a craft 100 in a vertical take-off and landing configuration, according to an exemplary embodiment of the present disclosure.

As shown in FIG. 1, the craft 100 may include, among other things, a body 110, one or more lift rotors 104, one or more proprotors 106 which may be mounted on respective hubs 107, one or more boom assemblies 150, one or more lift surfaces 102, and a tail 114. In some embodiments, the craft 100 may be manned or unmanned. It is envisioned that the craft 100 may be used for any purpose known to those skilled in the art, including for example, as a taxi, a delivery vehicle, a personal vehicle, a cargo transport, a short or long-distance hauling aircraft, and/or a video/photography craft. Thus, in some embodiments, the craft 100 may be a manned and/or unmanned aerial vehicle (e.g., aircraft).

The body 110 may be any suitable shape, size, or configuration suitable for the purpose of the craft, as will be understood by a person of ordinary skill in the art. For example, the body 110 may be oval, square, triangular, or otherwise any appropriate shape sufficient to hold cargo and/or passengers while remaining structurally sound. Moreover, the body 110 may include gear 116 for landing on land and/or water, which may or may not be retractable. The gear 116 may be included at both the front and the back of the craft 100, and may include wheels, treads, pontoons, or other components that may aid the craft in landing in land and/or water. The body 110 may also include a cockpit 118 configured to hold a pilot, passenger(s), and/or cargo. In one example, the pilot may be located at the front of the aircraft and the passengers and/or cargo may be located behind the pilot. However, in other embodiments, the pilot could be located at any location within the body (or that the craft could be maneuvered without a pilot at least some of the time).

The body 110 may also include a windshield 120 of any suitable shape and size; one or more doors configured to open and/or close (e.g., by swinging, sliding, and/or raising/lowering) to allow ingress/egress of persons and/or cargo; one or more seats; and controls and/or a computer system configured to communicate and/or control craft systems for the craft, including for example, the proprotors 106, the lift rotors 104, and/or one or more control surfaces (e.g., elevator, rudder, ruddervator, actuator, spoiler, or other known controls/surfaces). The body 110 may include a fuselage configured to provide structure to connect and/or link a lift surface structure of the lift surface 102. In some embodiments, the fuselage may be of truss, monocoque, or semi-monocoque construction. The fuselage may be constructed of any suitable material, such as metal and/or a composite laminate. In some examples, the fuselage may include aluminum, while in other examples the fuselage may include a carbon fiber composite laminate. In further examples, the fuselage may include a combination of metal and composite laminate.

The proprotors 106 and/or the lift rotors 104 may be positioned above or away from control surfaces and/or portions of the body 110 such that a blade strike is unlikely or not possible. For example, the proprotors 106 may be spaced above a proprotor hub 107 and/or the lift rotors 104, when in a vertical take-off and landing configuration. The proprotors 106 may be spaced along the lift surface 102 and substantially above the body 110, and/or the lift rotors 104 may be spaced along the boom assemblies 150 and substantially above the body 110.

The proprotors 106 may be spaced along the lift surface 102 away from the tail 114 (e.g., outboard) to avoid a blade strike on the tail 114. For example, each proprotor 106 may be positioned at more than half the distance of one wing from the body 110 or, in some embodiments, more than two-thirds the distance of one wing from body 110.

The proprotors 106, the lift rotors 104, and/or controls may be operable by an onboard pilot, an onboard computer (e.g., autonomously), from a control outside of the craft (e.g., remotely), or a mixture of one or more of an onboard pilot, an onboard computer, and/or a control outside of the aircraft. The proprotor 106 may be configured to be controlled through a power control (e.g., throttle), a pitch control (e.g., collective) and/or an angle of attack control (e.g., cyclically), or any suitable combination of these controls. Each of these controls may comprise mechanical and electrical actuators, switches, or other controls known to one of ordinary skill in the art, in conjunction with one or more processors (e.g., within controllers, computers) to effect operation and management of each individual control or as a subset of controls or all controls altogether.

The lift surface 102 may extend relatively horizontally, when the craft is at rest, from one end to another. The lift surface 102 may include an airfoil configured to generate lift when air flows past it. The lift surface 102 may be a single continuous surface, or may include sections of lift surfaces, for example with one or more sections arranged inboard (e.g., towards the body 110) of the boom assemblies 150 (discussed below) and one or more sections arranged outboard (e.g., away from the body 110) of the boom assemblies 150. The lift surface 102 may incorporate portions of, or include shaped portions of, the body 110, the boom assemblies 150, and/or the proprotors 106 to generate lift and/or reduce drag as air flows past. In some examples, the lift surface 102 may be a wing.

The boom assemblies 150 may provide a structure for the tail structure 114, one or more electric motors for the one or more lift rotors 104, and/or one or more batteries to power the one or more lift rotors 104, and/or the one or more proprotors 106. The lift rotors 104 may also be connected to the craft's electrical and control systems. The boom assemblies 150 may be supported by the lift surface 102 and the internal structure of the lift surface. Thus, the structure of the lift surface 102 may efficiently provide lift to the craft 100 to carry persons or cargo while incorporating structure to support the boom assemblies 150, and/or additionally to support the proprotors 106 in horizontal thrust and vertical take-off and landing configurations. Additionally, the proprotors 106 can create stress on structure as it rotates, and it is thus advantageous to support the proprotors 106 through the lift surface 102 that comprises internal structural components, such as spars and ribs, that are capable of withstanding the stress from the proprotors 106 as they operate to generate thrust and as they rotate between configurations. Efficient use of the structure in the lift surface 102 can provide for a lighter craft, leading to less use of fuel and travel at greater speeds.

While FIG. 1 illustrates four lift rotors 104, any suitable number of lift rotors 104 may be incorporated in a craft (for example, the craft may utilize more or less than four lift rotors 104). Lift rotors 104 may be configured to generate substantially vertical thrust. Lift rotors 104 may operate at a fixed pitch and/or a fixed revolutions per minute (RPM). In some embodiments, the lift rotors 104 may be positioned on either side of a lift surface and along the boom assemblies 150. In some embodiments, the lift rotors 104 may be positioned on the lift surface 102.

The lift rotors 104 and the proprotors 106 may be mechanically powered by one or more electric motors. In some embodiments, each lift rotor 104 and/or proprotor 106 may be powered by a dedicated motor, or one or more lift rotors 104 and/or proprotors 106 may be powered by a shared motor. As one example, two lift rotors 104 along one boom assembly 150 may share a motor. The motors discussed herein may be traditional fuel powered motors, electric motors, and/or hybrid motors. In some embodiments, a motor and rotor may be connected to a transmission that controls the use power generated by the motor. The transmission may be a continuously variable transmission (CVT), or an automatic transmission, or a manual or semi-manual transmission to shift one or more gears to output differing amounts of power.

The lift rotors 104 and/or the proprotors 106 may be constant speed rotors or variable speed rotors. The lift rotors and/or the proprotors may be at a constant angle of attack or have a changeable angle of attack (e.g., changeable through one or more actuators).

Speed, position, and/or angle of attack may be changed and/or gear may be shifted individually, as a set at the same time, or for all proprotors 106 and/or all lift rotors 104 simultaneously. For example, four lift rotors 104 may all change speed at once to initiate a takeoff sequence and/or landing sequence. As another example, the proprotors 106 may be shifted from a take-off and landing configuration to a cruise condition simultaneously. As another example, two proprotors 106 and four lift rotors 104 may all change speed and/or angle of attack to affect a take-off and landing sequence simultaneously.

In some examples, the proprotors 106 may be puller rotors or pusher rotors. The proprotors 106 may include a thrust rotor (e.g., a propeller). In some examples, the proprotors 106 may be configured to move between a horizontal thrust configuration, a vertical thrust configuration, and/or any position in between. In such examples, the vertical thrust configuration may allow for slow flight (e.g., hovering and/or sub-horizontal stall velocity flight) and/or take-off and/or landing (e.g., vertical/short take-off and landing (V/STOL)).

The lift rotors 104 may be located at any position on the craft 100. As illustrated in FIG. 1, a first lift rotor 104 may be positioned forward of the lift surface 102 on a first side of the body, a second lift rotor 104 may be positioned aft of the lift surface on the first side of the body, a third lift rotor 104 may be positioned forward of the lift surface on a second side of the body, and a fourth lift rotor 104 may be positioned aft of the lift surface on the second side of the body. The lift rotors 104 may also be mounted on the one or more boom assemblies 150. The one or more boom assemblies 150 may include a battery pack configured to supply electrical power to one or more electric motors or may be utilized for storage of goods, electrical or mechanical components of the craft, or any other items known to those skilled in the art. While FIG. 1 illustrates two boom assemblies 150 configured substantially perpendicular to the top or bottom surface of the lift surface 102, in other embodiments more or less than two booms may be utilized, and they may be attached using known attachment techniques and/or arranged in any suitable configuration. The one or more boom assemblies 150 may include or connect to the tail 114 that comprises one or more control surfaces (e.g., one or more of an elevator, a rudder, a ruddervators, a spoiler, or similar).

Control surfaces may be on relatively vertical portions of the tail 114 or relatively horizontal portion 126 of the tail 114. The tail 114 may be linked aft of the boom assemblies 150. In some embodiments, the tail 114 may be linked aft of the lift surface 102. The tail 114 may comprise an elevator along the link between one boom assembly 150 and another boom assembly 150. The tail structure 114 may be aft of the body 110. The tail structure 114 may comprise control surfaces such as rudders and/or ruddervators, where the control surfaces extend upwards and/or downwards from the boom assemblies 150. In some embodiments, at least one control surface may be positioned at least partially above a rotation plane of the lift rotors. For example, a rudder, an elevator, or a ruddervators of the tail 114 may extend partially above the body 110 and/or the lift rotors 104. The tail 114 may be configured to provide control to the craft 100 through control surfaces that are positioned in a freestream (e.g., relatively undisrupted air) when the craft is in a horizontal thrust configuration.

A number of tail configurations are contemplated, including a T-tail, cruciform tail, dual tail, triple tail, V-tail, Bronco tail, low boom tail, or high boom tail. A Bronco tail may have relatively perpendicular vertical and horizontal surfaces. The tail 114 may have rounded edges between substantial vertical and horizontal surfaces to provide efficient support of substantially horizontal surfaces by the substantially vertical surfaces, considered when the craft 100 is at rest on a ground surface. In some embodiments, the tail 114 may extend from the body 110 and the boom assemblies 150 may be connected above the tail 114 extending from the body 110, where the connection of the boom assemblies 150 is separate from the tail 114 extending from the body 110 or connected to the tail 114 extending from the body 110.

The proprotors 106 may be connected to the lift surface 102 through a rotating linkage such as a rotating spar, and/or extending linkages. In some embodiments, the rotating spar may be actuated to rotate the proprotor 106 relative to the lift surface 102. The proprotors 106 may be positioned at any suitable location on the craft, including on the lift surface, on one or more sides of the body 110, on the boom assembly 150, or any other location. In some embodiments, extending linkages may be actuated to rotate the proprotor 106 relative to the lift surface 102. Actuators configured to actuate spars and/or rotating linkages may comprise one or more of a rotating actuator or a linear actuator.

The proprotors 106 may be configured in one configuration to rotate around and/or relative to an axis 108 substantially parallel with a ground surface and/or a lift surface, considered when the aircraft is at rest on the ground surface. As shown in FIG. 1, the axis 108 may extend along or within the lift surface 102 from one end of the lift surface 102 to another end of the lift surface 102. The lift surface may include a first partial lift surface 122 at a first end of the lift surface 102 and a second partial lift surface 122 at a second end of the lift surface 102. The first and second partial lift surfaces may have any shape suitable to maximize lift and minimize drag, thereby reducing fuel consumption. For example, the partial lift surface may be rectangular, circular, triangular, or any combination thereof.

In some embodiments, a first proprotor 106 may be attached to the first partial lift surface such that the first partial lift surface moves with the proprotors 106 during movement of the proprotor 106 relative to and/or rotation about axis 108. A second proprotor 106 may be attached to the second partial lift surface such that the second partial lift surface moves with the proprotors 106 during movement of the proprotor 106 relative to and/or rotation about axis 108. The partial lift surfaces 122 may include one or more control systems which may be operable by the pilot located in the cabin 118. The partial lift surfaces 122 may be operated via actuators, active inceptors, sidesticks, switches, and/or buttons and may be configured to generate lift for vertical take-off and/or landing craft in a horizontal thrust configuration.

In some embodiments, the partial lift surfaces 122 may be configured to generate lift in a vertical thrust configuration. In some embodiments, the partial lift surfaces 122 may comprise a wing portion with a similar cross-sectional area and/or airfoil shape to the rest of the lift surface 102 (e.g., partial lift surfaces 122 may comprise a continuation of the lift surface 102). In some embodiments, the partial lift surfaces 122 may comprise winglets, may consist of winglets, and in other embodiments, the partial lift surfaces 122 may not have winglets. Whether the partial lift surfaces 122 have winglets may depend on the type of cargo, travel time, and/or proprotor size. The partial lift surfaces 122 may each comprise a winglet 124 and a wing portion, as shown in FIG. 1. The winglets 124 may extend generally vertically from the end of the wing portions. In some embodiments, the winglets 124 may be configured to reduce drag.

In some embodiments, the proprotors 106 may be configured to rotate or move about the axis 108 along with the partial lift surfaces 122, where the proprotors 106 and the partial lift surfaces 122, 124 rotate outboard of the boom assemblies 150. In some embodiments, where the lift surface 102 is a separate structure from the boom assemblies 150, the proprotors 106 may move or rotate with the lift surface 102 aside from portions of the lift surface 102 that include the body 110. In some embodiments, the proprotors 106 may move or rotate such that only a portion of the proprotor hub 107 and the blades 106 move or rotate. In some embodiments, the proprotor hub 107 may move or rotate with the partial lift surface 122 about axis 108. Based on the shape of the lift surface 102, the lift surface not including the body 110 may rotate with the proprotors 106 to increase lift and decrease drag, thereby reducing fuel consumption. The lift surface 102 shape may also vary throughout a root to tip length. For example, the lift surface 102 may be rectangular shaped to support the weight of the body 110, and may be thinner out to the proprotor 106 to reduce drag when the proprotor 106 is configured for horizontal operation and wider when the proprotor 106 is configured for vertical operation.

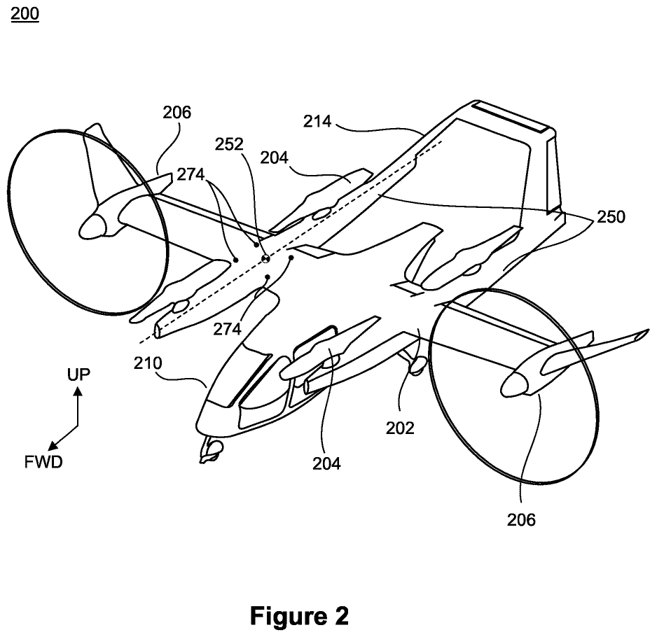

FIG. 2 illustrates a perspective view of aspects of a craft 200, according to an exemplary embodiment of the present disclosure. In some embodiments, the craft 200 may include a body 210, a lift surface 202, a boom assembly 250 coupled to a tail 214, lift rotors 204, and proprotors 206. The lift surface 202 may be coupled to the body 210 and the boom assembly 250. The boom assembly 250 may include the lift rotors 204 disposed along a length of the boom assembly 250, such as forward and aft of the lift surface 202. The boom assembly 250, together with the lift rotors 204 and tail 214 may define a center of gravity 252. The craft 200 may have similar components, features, and/or capabilities as the craft 100 described in FIG. 1.

In some embodiments, the lift surface 202 may include a structural unit, such as one or more spars, ribs, and/or hardpoints (e.g., pylons or lugs), configured to facilitate coupling of the boom assembly 250. Similarly, in some embodiments, the boom assembly 250 may include an internal and/or external structural unit that may couple to the structural unit of the lift surface 202. A portion of the boom assembly 250 may be shaped to mirror a portion of the lift surface 202 to facilitate coupling. For example, a portion of the boom assembly 250 may mirror an upper surface and/or a lower surface of the lift surface 202. In some embodiments, mirroring a surface of the lift surface 202 may reduce aerodynamic drag on the craft 200, thereby increasing aerodynamic efficiency. In the example shown in FIG. 2, the boom assembly 250 couples to the lift surface 202 such that the lift surface 202 is enclosed by the boom assembly 250 at the coupling location. In such examples, the boom assembly 250 may form an aperture shape substantially similar to the shape of the lift surface 202. A portion of the boom assembly 250 may reside above and below the lift surface 202. The portion of the boom assembly 250 residing above the lift surface 202 may match the contour of the upper surface of the lift surface 202. In some examples, the portion of the boom assembly 250 residing above the lift surface 202 may be structural, while in other examples the portion of the boom assembly 250 residing above the lift surface 202 may serve an aerodynamic purpose (e.g., a fairing). In such examples, the structural portion of the boom assembly 250 may reside below the lift surface 202. In further examples, the boom assembly 250 may reside completely below the lift surface 202, completely above the lift surface 202, or substantially in-line with the lift surface 202.

As shown, the craft 200 may include the boom assembly 250 disposed on the lift surface 202 and located on either side of the body 210. For example, the craft 200 may include a first boom assembly disposed on a first side of the body 210 and a second boom assembly disposed on a second side, opposite the first side, of the body 210. A first portion of each boom assembly 250 may extend forward of the lift surface 202 and a second portion of each boom assembly 250 may extend aft of the lift surface 202. The first and second portions of each boom assembly 250 may each respectively include the lift rotors 204.

In some examples, the lift rotors 204 may be disposed on the boom assembly 250 and extend above an upper surface of the lift surface 202. Having the lift rotors 204 extend above the lift surface 202 may allow for improved aerodynamic performance of the craft 200 by reducing interference of airflow over the lift surface 202 during flight. This may further provide increased safety to pilots, passengers, and crew as the lift rotors 204 are not in line with the body 210. In some examples, the portion of the boom assembly 250 below the lift surface 202 may be structural, while the portion of the boom assembly 250 in-line with and/or above the lift surface 202 may be non-structural, such as an aerodynamic fairing.

In some examples, non-structural components may experience loading, for example gravitational forces, but the structural load carrying capabilities of the non-structural part are not contemplated in the load carrying capabilities of the overall structure.

The boom 250 may be coupled to the lift surface 202 at one or more attachment points 274. In the example of FIG. 2, four attachment points 274 are shown, however in other examples any number of attachment points 274 may be used. For instance, in some examples fewer than four attachment points 274, such as two, may be used, while in other examples more than four attachment points 274, such as six, may be used. One or more of the attachment points 274 may be forward of the center of gravity 252 while one or more of the attachment points 274 may be aft of the center of gravity 252. Similarly, one or more of the attachment points 274 may be inboard of the center of gravity 252 while one or more of the attachment points 274 may be outboard of the center of gravity 252. For example, attachment points 274 may be disposed at each of a forward-inboard location, a forward-outboard location, an aft-inboard location, and an aft-outboard location relative to the center of gravity 252. In such examples, the forward and/or aft attachment points 274 may be spaced equidistant from the center of gravity 252.

The one or more attachment points 274 may facilitate coupling of the boom 250 to the lift surface 202. In some examples, it may be desirable for the boom 250 to detach from the lift surface 202 upon the lift surface 202 exceeding a threshold load. For example, during a hard landing condition loading on the lift surface 202 may exceed the load carrying capabilities of the lift surface 202, such as exceeding a design load and/or a maximum load. To reduce loading, it may be desirable to shed weight carried by the lift surface 202 by detaching of structures coupled to the lift surface 202, such as the boom 250. In such examples, one or more of the attachment points 274 may be detachably coupled to the lift surface 202. Upon exceeding the threshold load, the boom 250 may detach from the lift surface 202 at the attachment points 274, reducing loading transferred through the lift surface 202. Thus, in some examples the boom 250 may be a detachable structure.

While the attachment points 274 are shown in FIG. 2 as coupling the lift surface 202 to the boom 250, in other examples the attachment points 274 may be located anywhere on the craft 200 and couple any plurality of structures. In some examples, an aircraft includes a first aircraft structure and a second aircraft structure coupled to the first aircraft structure. In such examples, one or more of the attachment points 274 may couple the first aircraft structure to the second aircraft structure. The first and second aircraft structures may be any of the individual or combined structures, components, and/or parts previously described with respect to FIG. 1 and/or FIG. 2. Non-limiting examples of the first and second aircraft structures include the lift surface 102 (e.g., the wing) coupled to the boom 150, the boom 150 coupled to the tail 114, the boom 150 including the tail 114 coupled to the lift surface 102, and/or the lift surface 102 coupled to the body 110. In some examples, the first aircraft structure may be a first wing portion (e.g., a first portion of the lift surface 102) proximal to the body 110 and the second aircraft structure may be a second wing portion (e.g., a second portion of the lift surface 102) distal to the body 110.

While the craft 200 has an overall center of gravity, in some examples each of the respective individual or combined structures, components, and/or parts previously described with respect to FIG. 1 and/or FIG. 2 may include a local center of gravity. For example, an individual component on the craft 200 may have a local center of gravity in addition to contributing to the center of gravity of the craft 200. Similarly the combination of components, such as the combination of the boom 150, the lift rotors 104, and the tail 114 may form the local center of gravity that may be a composite center of gravity of the coupled components. In some examples, the local center of gravity may be different than the center of gravity of the craft 200. In such examples, one or more of the attachment points 274 may be positioned relative to the local center of gravity, such as the local center of gravity of the detachable structure. In examples where it is desirable to detach the second aircraft structure, one or more of the attachment points 274 may be positioned relative to the local center of gravity of the second aircraft structure.

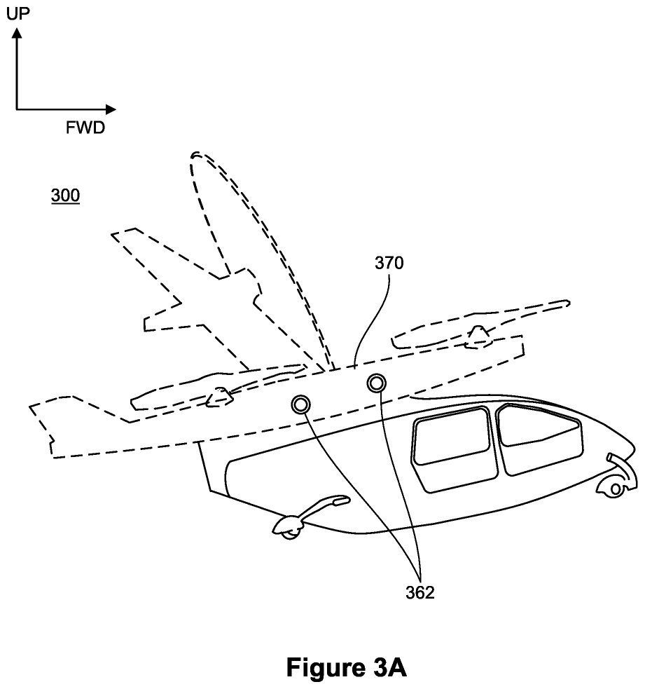

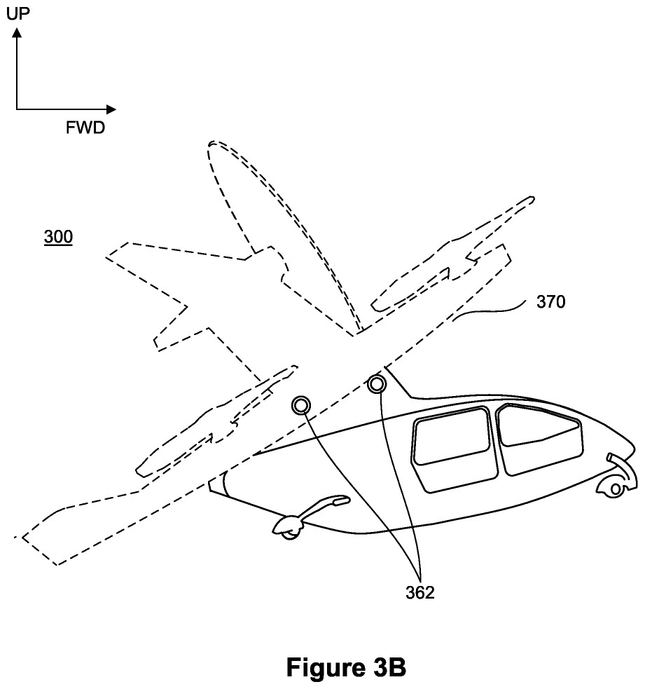

FIGS. 3A-3B illustrate an aircraft 300 including a detachable structure 370, according to an exemplary embodiment of the present disclosure.

As a person of ordinary skill in the art will understand, certain features of aircraft 300 may be the same or similar to those of exemplary craft 100 and/or 200 discussed above.

FIG. 3A shows an exemplary aircraft 300 in a normal state (e.g., where one or more fuse pins are non-deformed, non-fractured, or non-severed). FIG. 3B shows the exemplary aircraft 300 in an abnormal state (e.g., where one or more fuse pins are deformed, fractured, or severed). The aircraft 300 may comprise one or more fuse pins 362. Fuse pins 362 may be part of any structure of the aircraft 300, such as lift surface 102, booms 150, and/or body 110 of FIG. 1. The one or more fuse pins 362 may be located at a coupling/connection point between a first structure and a second structure, where detachment or translation of the first structure from the second structure may be desired. For example, the one or more fuse pins 362 may couple a structure of the wing, such as a spar, a rib, a lug, and/or a pylon, to a coupling structure of the boom. In such examples, the one or more fuse pins 362 may facilitate translation of the boom relative to the wing upon plastic deformation of the one or more fuse pins 362. The one or more fuse pins 362 may allow detachment of the boom from the wing, at the respective coupling location, upon breaking (e.g., shearing and/or fracturing) of the one or more fuse pins 362.

The one or more fuse pins 362 may be anywhere laterally (e.g., from side-to-side of an airplane when looking at the front of an airplane) along a wing or other structure of an aircraft. In such examples, the one or more fuse pins 362 may be considered longitudinal with respect to the lift surface 202 of FIG. 2. However, in other examples the one or more fuse pins 362 may be aligned substantially longitudinal with the body 110 and/or disposed perpendicular (e.g., vertically) relative to an aircraft structure, such as the lift surface 102. The one or more fuse pins 362 may be configured to deform before one or more other structures of the lift surface 102, such as a stringer, a strut, a spar, or a rib or any other structure of a lift surface as would be known to one of ordinary skill in the art. One or more fuse pins 362 may be configured to deform before one or more other structures of the boom 150, such as a connecting structure of the boom 150, a stringer, a spar, a strut, or a rib or any other structure of a boom as would be known to one of ordinary skill in the art.

As used herein, the term deform includes plastic deformation and/or fracture. Fracture includes breaking, shearing, and/or any failure mode at which a single part becomes a plurality of sub-parts upon exceeding a specified load (e.g., the fracture point on a stress-strain curve). Thus, in some examples deform includes all points along a stress-strain curve beyond the yield point.

For example, the lift surface 102 (e.g., the wing) may be designed to sustain a specific load factor (G-force) while coupled to the boom 150 and/or proprotors 106. Certain conditions, such as hard landing conditions, may exceed the design limit load factor of the lift surface 102. Exceeding the design load factor may cause damage to the lift surface and/or the body 110 as the loading is transferred through the aircraft 300. It may be desirable to shed weight from the lift surface 102 to reduce the load factor on the lift surface 102 and thus mitigate potential damage to the aircraft 300. In some examples, weight may be shed from the lift surface 102 by detaching coupled structures, such as the boom 150 and/or the proprotors 106. For instance, the one or more fuse pins 362 may couple the boom 150 and/or the proprotors 106 to the lift surface 102 and allow for detachment from the lift surface 102 at the coupling location. The one or more fuse pins 362 may be designed to deform (e.g., break, fracture, shear, and/or plastically deform) upon exceeding a desired threshold load. For example, the one or more fuse pins 362 may be designed to deform at a load factor greater than the design load factor of the lift surface 102 such that weight from the coupled structure (e.g., the boom 150 and/or the proprotors 106) is shifted off of the lift surface 102 to mitigate forces exceeding the design limit of the lift surface 102. Thus, the one or more fuse pins 362 may allow the lift surface 102 to operate up to the design limit while mitigating damage to the lift surface 102 and/or aircraft 300 when the design limit is exceeded.

The one or more fuse pins 362 may be of any length. The one or more fuse pins 362 may be relatively short for a single connection (e.g., a connection of the lift surface 102 to the body 110), or fuse pins 362 may relatively long such as nearly as long as the lift surface 102. A longer fuse pin may allow for more through load to be transferred between the coupled parts, however the longer fuse pin may add additional weight to the aircraft 300. In some examples, the one or more fuse pins 362 may be designed to operate by shearing. In such examples, a relatively short fuse pin may provide desirable shear characteristics while reducing additional weight on the aircraft 300. In examples where a relatively short fuse pin is employed, the coupling structure may be designed to accommodate peak stresses arising from the fuse pin.

FIG. 3A shows the one or more fuse pins 362 non-fractured, non-deformed, non-severed, and connecting one or more structures of aircraft 300. In this configuration, the detachable structure 370 is attached. Detachable structure 370 may comprise one or more of a portion of the body 110, part or all of the lift surface 102, part or all of the booms 150, the tail 114, the lift rotors 104, the proprotors 106, or any structures or devices to support these devices or structures as described or shown with reference to FIG. 1 and/or FIG. 2. Thus, the one or more fuse pins 362 may form a coupling between a first structure and a second structure where it may be desirable for the second structure to decouple at the location of the one or more fuse pins 362.

FIG. 3B shows one or more of the fuse pins 362 severed, for example along the length of a fuse pin. One or more fuse pins 362 may be plastically deformed, severed, and/or fractured in this state. As a result of a deformation of one or more fuse pins 362, detachable structure 370 may comprise structures that are designed to break or detach. For example, the detachable structure 370 may comprise a boom assembly, and the boom assembly may be configured to detach when experiencing a threshold load after the one or more fuse pins 362 plastically deforms, severs, or fractures. Thus, the one or more fuse pins 362 may plastically deform, sever, or fracture upon reaching and/or exceeding the threshold load. One or more fuse pins 362 may no longer connect one or more structures of the aircraft 300 when severed.

For example, structure of the lift surface 102, the boom 150, and one or more proprotors and/or lift rotors and associated devices and structure may avoid damaging/striking the body 110 when the one or more fuse pins 362 plastically deforms, severs, or fractures at and/or above the threshold load. In some examples, the threshold load may be due to a heavy load condition such as a microburst weather condition (e.g., gust loading condition) and/or a hard landing condition that exceeds the design limit load of the lift surface 102 and/or the body 110. Thus, in some examples the threshold load is greater than the design limit load of one or more components of the aircraft 300.

In examples where the one or more fuse pins 362 comprises two pins (as shown in FIG. 3B), both pins may be configured to plastically deform, sever, or fracture simultaneously such that detachable structure 370 may detach. In some examples, an explosive bolt, a ballistic detachment cable or bolt, or another detachable structure as would be understood by one or ordinary skill in the art may be used to fracture or plastically deform the one or more fuse pins 362 or detachable structure.

In some examples, the one or more fuse pins 362 may connect the lift surface 102 to the boom 150. In such examples, the detachable structure 370 may comprise part of the lift surface 102, the boom 150, the tail 114, the lift rotors 104, the proprotors 106, and supporting structure and devices, as previously described with respect to FIG. 1.

In some examples, where the one or more fuse pins 362 consists of two pins, the aft pin may be configured to fail before the forward pin. In some embodiments, the forward pin may have a higher threshold for fracturing or experiencing plastic deformation than the aft pin. In examples, an explosive bolt or another detachable structure as would be understood by one or ordinary skill in the art may be used to detach the aft pin before the forward pin. In such examples, this configuration may be used for the lift surface 102 to the boom 150 connection. A benefit to this configuration is that forward lift rotors 104 and/or proprotors 106 are lifted away from the body 110, thus causing detachable structure 370 to avoid damage to the body 110. For example, aft detachable structure 370 may fall first as shown in FIG. 3B. Another benefit is that the detachable structure may be detached and thus not prevent egress of occupants within the body 110.

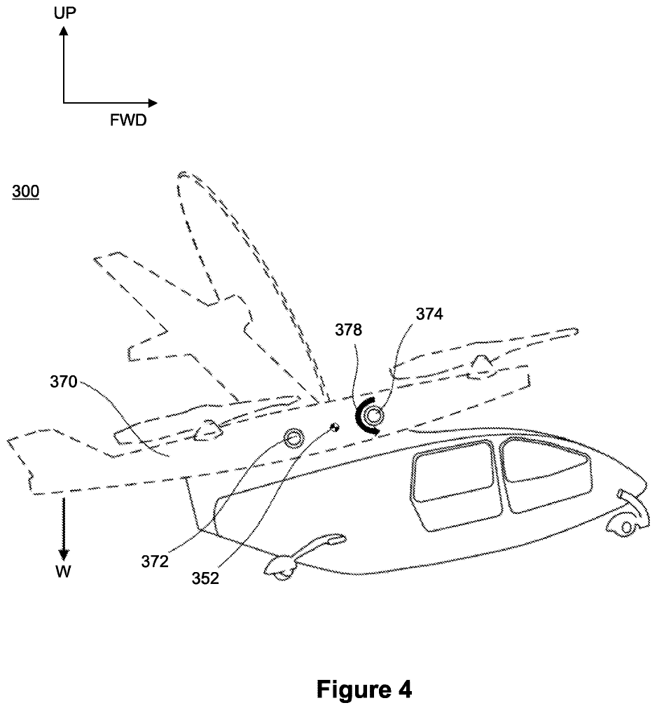

FIG. 4 illustrates the aircraft 300 having the detachable structure 370, according to an exemplary embodiment of the present disclosure. The detachable structure 370 includes a first attachment point 372 and a second attachment point 374. The first and second attachment points 372 and 374 may provide coupling to another structure of the aircraft 300, such as the lift surface 202 and/or the body 210. The detachable structure 370 may include one or more coupled parts. For example, the detachable structure 370 may include the boom 250, the lift rotors 204 disposed on the boom 250, and the tail 214 coupled to the boom 250. In the example shown, a center of gravity 352 of the detachable structure 370 lies between the first and second attachment points 372 and 374. However, in other examples, the center of gravity 352 may lie elsewhere.

Each of the first and second attachment points 372 and 374 of the detachable structure 370 may include one or more fuse pins, such as the fuse pin 362. In some examples, fuse pins having different characteristics may be used at each of the first and second attachment points 372 and 374. For example, the first attachment point 372 may include a fuse pin designed to shear upon exceeding a first threshold load while the second attachment point may include a fuse pin designed to yield (e.g., plastically deform) upon exceeding a second threshold load. In other examples, the first attachment point 372 may include the fuse pin 362 and the second attachment point 374 may include a pivoting structure, such as a fixed bolt, a rod, or a bar. The second attachment point 374 may act as a point of rotation 378 about which the detachable structure 370 may rotate. For example, during a hard landing condition it may be desirable to reduce weight on the lift surface 202 while also avoiding blocking ingress/egress from the aircraft 300. Thus, in some examples it may be desirable to selectively detach the detachable structure 370 from one attachment point (e.g., the first attachment point 372) while maintaining attachment at another attachment point (e.g., the second attachment point 374).

In examples where the fuse pin 362 is located at the first attachment point 372 and the pivoting structure (e.g., a rod or bar) is located at the second attachment point 374, the fuse pin 362 at the first attachment point 372 may shear upon exceeding the threshold load. Shearing of the fuse pin 362 may sever connection of the detachable structure 370 at the first attachment point 372 which may help to shed weight from the lift surface 202. For example, force that may otherwise be transferred through the lift surface 202 and/or the body 210 may instead provide shearing of the fuse pin 362.

The center of gravity 352 may be located aft of the second attachment point 374, such that upon shearing of the fuse pin 362 at the first attachment point 372 the second attachment point 374 acts as a point of rotation 378 for the detachable structure 370. With the center of gravity 352 aft of the second attachment point 374 the weight (W) of the detachable structure 370 may cause the detachable structure 370 to rotate about the second attachment point 374 such that a forward end of the detachable structure 370 is pitched upwardly and an aft end of the detachable structure 370 is pitched downwardly.

Thus, the detachable structure 370 aft of the second attachment point 374 may rotate downwardly. By downwardly pitching the aft portion and upwardly pitching the forward portion of the detachable structure 370 one or more lift rotors 204, booms 250, and/or other structure may be elevated away from the ingress/egress of the aircraft 300, which may allow for uninhibited egress from the aircraft 300 in the event of an emergency. Further, moving the lift rotors 204 up and away from the ingress/egress may increase separation between the blades and the occupants, which may increase safety to the occupants.

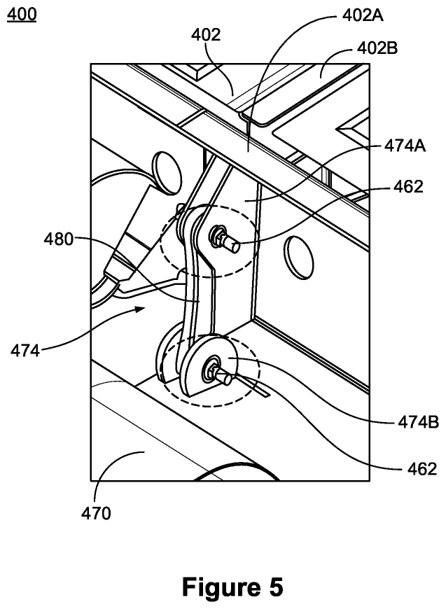

FIG. 5 illustrates an attachment point 474 on an aircraft 400, according to an exemplary embodiment of the present disclosure. The aircraft 400 includes a lift surface 402 coupled to a detachable structure 470 by way of the attachment point 474. The lift surface 402 includes a spar 402A and a coupling structure 402B. The attachment point 474 includes a first attachment section 474A and a second attachment section 474B coupled by way of a pivot bar 480.

As shown, the first attachment section 474A is part of the coupling structure 402B. The coupling structure 402B may be any structure on the lift surface 402, such as a rib, a bulkhead, a flange, a hardpoint (e.g., a pylon or a lug), and/or the spar 402A. For example, if the pylon is present, the first attachment section 474A may be part of the pylon. In the example shown, the first attachment section 474A includes a first flanged portion and a second flanged portion disposed perpendicular to the spar 402A in a forward/aft orientation. The first and second flanged portions may be disposed at a distance from one another to allow the pivot bar 480 to be disposed between the first and second flanged portions. While two flanged portions are shown, in other examples at least one flanged portion may be used. To facilitate coupling with the pivot bar 480 and/or the detachable structure 470, the first attachment section 474A may include an aperture. For example, a fuse pin 462 may be disposed within the aperture and couple the first attachment section 474A to the pivot bar 480. However, in other examples another fastening means, such as a fixed bolt/pin, a rod, or a bar, may couple the first attachment section 474A to the pivot bar 480.

In the example shown, the second attachment section 474B is disposed on the detachable structure 470. The second attachment section 474B provides coupling of the detachable structure 470 to the first attachment section 474A on the non-detachable structure, such as the lift surface 402, by way of the pivot bar 480. Similar to the first attachment section 474A, the pivot bar 480 may be disposed between a first and second flanged portion of the second attachment section 474B. The second attachment section 474B may include an aperture to facilitate coupling to the first attachment section 474A. Fastening means, such as the fuse pin 462 or a fixed bolt/pin may be disposed in the aperture and couple the second attachment section 474B the first attachment section 474A by way of the pivot bar 480.

In some examples, the pivot bar 480 may be coupled at a first end to the first attachment section 474A and at a second end to the second attachment section 474B. The first end of the pivot bar 480 may be opposite of the second end. Thus, in some examples the pivot bar 480 couples the detachable structure 470 to the lift surface 402 at a first attachment section 474A and a second attachment section 474B. In such examples, the fuse pin 462 may provide coupling of the detachable structure 470 to the lift surface 402 at either the first and/or second attachment sections 474A and 474B, respectively. The fuse pins 462 may be the same and/or similar to the fuse pins 362 previously described.

In some examples, the first and/or second attachment sections 474A and 474B may provide a point of pivot about which the detachable structure 470 rotates. The pivot bar 480 may enable pivoting about both the first and second attachment sections 474A and 474B. For example, the attachment point 474 may be the second attachment point 374, shown in FIG. 3. Upon detachment of the detachable structure 470 at the first attachment point 372, such as through shearing of the fuse pin upon exceeding a threshold load, the detachable structure 470 may pivot about the attachment point 474. In such examples, the detachable structure 470 may rotate/pivot about the coupling at the second attachment section 474B such that a portion of the detachable structure 470 aft of the attachment point 474 pitches in a first direction (e.g., downward) and a portion of the detachable structure 470 forward of the attachment point 474 pitches in a second direction (e.g., upward).

In some examples, the pivot bar 480 may allow the detachable structure 470 to also rotate/pivot about the first attachment section 474A. For example, the pivot bar 480 may act as a swing arm to allow the detachable structure 470 to swing away from the lift surface 402 as the detachable structure 470 is rotating. Allowing for swing and/or dual points of rotation/pivot may mitigate unintentional damage to the lift surface 402 (e.g., the non-detachable structure) by reducing a likelihood that the detachable structure 470 collides with the lift surface 402 during rotation. Sleeves, bushings, and/or bearings may be employed within the apertures to facilitate rotation/pivoting as well as increase bearing area to reduce peak stresses at the coupling location.

While the attachment point 474 has been described as the second attachment point 374, in FIG. 3, in some examples both the first and second attachment points 372 and 374 may be the attachment point 474. In other examples, the detachable structure 470 may be coupled at more than two attachment points to the non-detachable structure (e.g., the lift surface 402). One or more points of coupling between the detachable structure 470 and the non-detachable structure may include the attachment point 474.

In some examples, the fastening means used, such as fixed bolts/pins and/or shear pins 462, is based on a location of the attachment point 474. For instance, where the aircraft 400 includes a plurality of attachment points 474 one or more of the attachment points 474 may be designed to detach, decouple, and/or deform in response to exceeding the threshold load, while one or more of the attachment points 474 may be designed to act as the point of rotation/pivot. In such examples, the shear pins 462 may provide coupling at either the first and/or second attachment sections 474A and 474B of the attachment points 474 where detachment, decoupling, and/or deformation is desirable, while fixed bolts/pins may provide coupling at either the first and/or second attachment sections 474A and 474B of the attachment points 474 where rotation/pivoting is desirable.

However, in some examples the fuse pins 462 may be used at the attachment points 474 where rotation/pivoting is desirable. The fuse pins 462 may yield (e.g., deform) in response to the threshold load being exceeded, such as yielding at the second attachment section 474B but not the first attachment section 474A. Yielding at the second attachment section 474B of the fuse pins 462 at the point of rotation/pivot may shed weight from transferring into the lift structure 402 while still allowing the detachable structure 470 to pivot via the pivot bar 480 about the first attachment section 474A.

### Example Embodiments

1. An aircraft comprises a body, a wing connected to the body, a boom connected to the wing, and a fuse pin disposed along the wing and connecting the wing to the boom. The fuse pin is configured to fracture, sever, or plastically deform under a threshold load such that a portion of the wing and the boom detaches from the body.

2. In an embodiment of example 1, the fuse pin comprises a forward pin and an aft pin, wherein the aft pin is configured to fracture or plastically deform before the forward pin.

3. An aircraft comprises a body, a wing connected to the body, and a fuse pin disposed along the wing and connecting the wing to the body. The fuse pin is configured to fracture, sever, or plastically deform under a threshold load such that at least a portion of the wing detaches from the body.

4. An aircraft comprises a body. The aircraft also comprises a wing connected to the body. The wing comprises a first portion distal to the wing and a second portion proximal to the wing. The aircraft further comprises a fuse pin disposed along the wing and connecting the first portion to the second portion. The fuse pin is configured to fracture, sever, or plastically deform under a threshold load such that the first portion of the wing detaches from the second portion.

It will be apparent to those skilled in the art that various modifications and variations can be made to the disclosed aircraft or vehicles.

While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

What is claimed is:

1. An aircraft comprising:
a body;
a wing coupled to the body;
a boom coupled to the wing at a first location and a second location; and
a fuse pin coupling the boom to the wing at the second location, wherein the fuse pin is configured to fracture or plastically deform above a threshold load.

2. The aircraft of claim 1, wherein the fuse pin comprises a forward pin and an aft pin, wherein the aft pin is configured to fracture or plastically deform before the forward pin.

3. The aircraft of any of claims 1-2, further comprising a second fuse pin at the first location, wherein the second fuse pin is configured to fracture or plastically deform above a second threshold load different than the threshold load.

4. The aircraft of claim 3, wherein upon exceeding the threshold load, the boom detaches from the wing at the second location and the first location forms a pivot point, and wherein upon exceeding the second threshold load, the boom completely detaches from the wing at the first and second location.

5. The aircraft of any of claims 1-4, wherein the fuse pin comprises an upper fuse pin and a lower fuse pin, wherein the lower fuse pin is configured to fracture or plastically deform before the upper fuse pin.

6. The aircraft of any of claims 1-5, wherein the boom comprises a center of gravity, wherein the first location is on a first side of the center of gravity and the second location is on a second side opposite the first side.

7. The aircraft of claim 6, wherein the first side is forward of the center of gravity and the second side is aft of the center of gravity.

8. The aircraft of any of claims 1-7, wherein the first location forms a pivot point for the boom, such that upon fracture of the fuse pin at the second location, the boom rotates about the pivot point.

9. The aircraft of any of claims 1-8, wherein the first location further comprises the fuse pin.

10. The aircraft of any of claims 1-9, wherein a length of the fuse pin is aligned longitudinal with the wing.

11. The aircraft of any of claims 1-10, wherein a pivot bar couples the boom to the wing at either the first and/or second location, the pivot bar coupled at a first end to the wing and at a second end to the boom.

12. The aircraft of claim 11, wherein the first end forms a pivot point about which the boom and the pivot bar rotate.

13. The aircraft of any of claims 11-12, wherein the fuse pin couples the boom to the pivot bar at the second end.

14. The aircraft of any of claims 11-13, wherein at least one fixed bolt couples the pivot bar to the boom and the wing at the first location and at least one of the fuse pins couples a second pivot bar to the boom and the wing at the second location, such that the boom detaches from the wing at the second location upon exceeding the threshold load.

15. An aircraft comprising:
a first aircraft structure;
a second aircraft structure coupled to the first aircraft structure, wherein the second aircraft structure comprises a local center of gravity; and
a fuse pin coupling the first aircraft structure to the second aircraft structure aft of the local center of gravity, wherein the fuse pin is configured to fracture or plastically deform above a threshold load.

16. The aircraft of claim 15, wherein the first aircraft structure is coupled to the second aircraft structure at a first location forward of the local center of gravity and a second location aft of the local center of gravity.

17. The aircraft of claim 16, wherein the fuse pin couples the first aircraft structure to the second aircraft structure at the second location and the first aircraft structure is pivotally coupled to the second aircraft structure at the first location.

18. The aircraft of any of claims 15-17, wherein the second aircraft structure detaches from the first aircraft structure at the second location upon exceeding the threshold load and rotates about the first location.

19. The aircraft of any of claims 15-18, wherein the second location comprises the fuse pin and the first location comprises a second fuse pin, the second fuse pin configured to fracture or plastically deform above a second threshold load different than the threshold load.

20. The aircraft of any of claims 15-19, wherein upon exceeding the threshold load the second aircraft structure detaches from the first aircraft structure at the second location and the first location forms a pivot point, and wherein upon exceeding the second threshold load the second aircraft structure completely detaches from the first aircraft structure at the first and second location.

21. The aircraft of any of claims 16-20, wherein a pivot bar couples the first aircraft structure to the second aircraft structure at either the first and/or second location, the pivot bar coupled at a first end to the first aircraft structure and at a second end to the second aircraft structure.

22. The aircraft of claim 21, wherein the first end forms a pivot point about which the second aircraft structure and the pivot bar rotate.

23. The aircraft of any of claims 21-22, wherein the fuse pin couples the second aircraft structure to the pivot bar at the second end.

24. The aircraft of any of claims 15-23, wherein the first aircraft structure is a first wing portion proximal to a body of the aircraft and the second aircraft structure is a second wing portion distal to the body.
